(19) United States
(12) Patent Application Publication
(10) Pub. No.: US 2026/0311048 A1
(43) Pub. Date: Oct. 8, 2026

(54) VISION FINE-TUNING FOR MACHINE LEARNING MODEL AND APPLICATION PROGRAMMING INTERFACE (API)

(71) Applicant: OpenAI OpCo, LLC., San Francisco, CA (US)

(72) Inventors: John Allard, San Francisco, CA (US); James Blomo, San Carlos, CA (US); William Hang, San Francisco, CA (US); Steven Heidel, San Francisco, CA (US); Todd Hendry, Bothell, WA (US); Radu Kopetz, San Francisco, CA (US); Ravi Teja Mullapudi, Palo Alto, CA (US); Damian Mrowca, San Francisco, CA (US); Sherwin Wu, San Francisco, CA (US)

(73) Assignee: OpenAI OpCo, LLC., San Francisco, CA (US)

(21) Appl. No.: 19/240,232

(22) Filed: Jun. 17, 2025

Related U.S. Application Data
(63) Continuation of application No. 19/090,901, filed on Mar. 26, 2025, now abandoned.

(51) Int. Cl. G06N 20/00; G06T 3/40; G06T 7/11

(52) U.S. Cl. CPC G06N 20/00; G06T 3/40; G06T 7/11

(57) ABSTRACT

The present technology pertains to a fine-tuned generative response engine that accepts multi-modal inputs include text and one or more images. A training set for fine-tuning the engine/model (e.g., a machine learning model) can be received via an application programming interface (API) call to an API. The training set includes inputs having input images associated with input text. Further, for supervised learning the training sets can include output text (e.g., completions that are the desired generated responses). The API call can indicate a base model (or previously fine-tuned model) to be fine-tuned. The API can cause a fine-tuned model to be trained based on the base model and the training set and can return a name for the fine-tuned model. To use the fine-tuned model to generate a response to a prompt, a subsequent API call includes the name and the prompt.

### CROSS-REFERENCE TO RELATED APPLICATIONS

This application is a continuation of and claims priority to U.S. application Ser. No. 19/090,901, filed on Mar. 26, 2025, entitled VISION FINE-TUNING FOR MACHINE LEARNING MODEL AND APPLICATION PROGRAMMING INTERFACE (API), which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates a block diagram of an example of a fine-tuned machine learning (ML) model with a separate embedding layer in accordance with some embodiments of the present technology.

FIG. 1B illustrates a block diagram of an example of a fine-tuned machine learning (ML) model without a separate embedding layer in accordance with some embodiments of the present technology.

FIG. 2A illustrates a block diagram of an example of a pretrained layer of an ML model in accordance with some embodiments of the present technology.

FIG. 2B illustrates a block diagram of an example of a fine-tuned layer of an ML model in accordance with some embodiments of the present technology.

FIG. 3A illustrates an example of a process flow for fine-tuning an ML model in accordance with some embodiments of the present technology.

FIG. 3B illustrates an example of a process flow for using a fine-tuned ML model in accordance with some embodiments of the present technology.

FIG. 4 illustrates a flow diagram of an example of a method for fine-tuning an ML model and using the fine-tuned ML model in accordance with some embodiments of the present technology.

FIG. 5A illustrates an example of an oversized image that exceeds a maximum image size in accordance with some embodiments of the present technology.

FIG. 5B illustrates an example of resizing the oversized image to not exceed the maximum image size in accordance with some embodiments of the present technology.

FIG. 5C illustrates an example of subdividing the oversized image into tiles that separately do not exceed the maximum image size in accordance with some embodiments of the present technology.

FIGS. 6A-6E illustrate respective views of an example of a user interface of an application programming interface (API) that is used to access and generate fine-tuned ML models in accordance with some embodiments of the present technology.

FIGS. 7A-7D illustrate respective views of an example of a popup window of the API that is used to define a new fine-tuned ML model in accordance with some embodiments of the present technology.

FIG. 8 illustrates an example system supporting a generative response engine during inference operations in accordance with some embodiments of the present technology.

FIG. 9 is a block diagram illustrating an example ML platform for implementing various aspects of this disclosure in accordance with some aspects of the present technology.

FIGS. 10A-10C illustrates an example transformer architecture in accordance with some embodiments of the present technology.

FIG. 11 shows an example of a computing system for implementing some embodiments of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines operate on a foundation of publicly available information and do not possess personal information about individual users.

Many generative response engines provide a conversational user interface powered by a chatbot whereby the user account interacts with the generative response engine through natural language conversation with the chatbot. Such a user interface provides an intuitive format to provide prompts or instructions to the generative response engine.

A new direction for generative response engines is to generate responses based on multi-modal inputs, such as a combination of image inputs and text inputs. Multi-modal artificial intelligence (AI) models can process multiple forms of input, such as text, images, audio, and video. These models combine information from different modalities to provide more comprehensive responses or perform complex tasks that would be difficult for single-modality systems. To harness the potential of multi-modal AI models, improved systems and methods are desired to interface with, train, and use these models.

Further, generative response engines could be improved by enabling generative response engines to be fine-tuned for particular tasks using training sets that include multi-modal inputs. Such fine-tuning can be enabled by an application programming interface adapted for users to upload training sets that include multi-modal inputs of images and text. Further, the uploaded training sets can include outputs/completions that can be used as supervised learning to fine-tune a specified base model.

As discussed above, multi-modal artificial intelligence (AI) models provide the benefit of combining information from different modalities to provide more comprehensive responses or perform complex tasks that would be difficult for single-modality systems. The systems and methods disclosed herein can include an application programming interface (API) and a user interface (UI) that enable users to fine-tune a base model for a particular task that uses multi-modal inputs to generate responses.

As a non-limiting example, the systems and methods disclosed herein can enable users to perform vision fine-tuning on a based model, such as GPT-4o from OPENAI, making it possible to fine-tune with images in addition to text. According to certain non-limiting examples, vision fine-tuning can enhance the base model's ability to understand and interpret images, making it suitable for applications such as improved visual search functionality, better object detection for autonomous vehicles and smart cities, and more accurate medical image analysis, as discussed above. Developers can achieve significant performance improvements with as few as 100 images, and performance scales with the size of the training set.

In some cases, fine-tuning models based solely on text inputs fail to provide the performance boosts that can be achieved using multi-modal inputs. Vision fine-tuning can be performed using a similar process to fine-tuning with text. For example, developers can prepare their image training set to follow a designated format and then upload that training set to the fine-tuning platform. According to certain non-limiting examples, the base model can be fine-tuned to improve its performance for vision tasks using a training set with as few as 100 images, with greater performance improvements realized by using a larger training set.

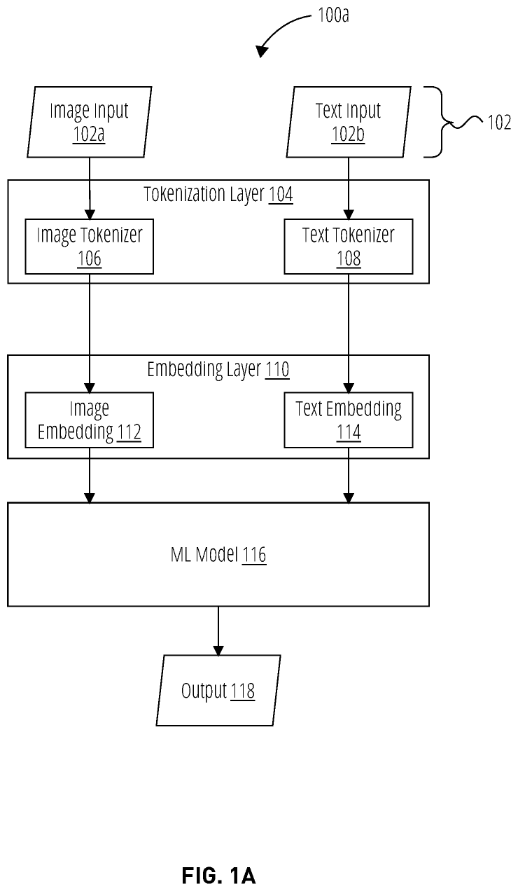

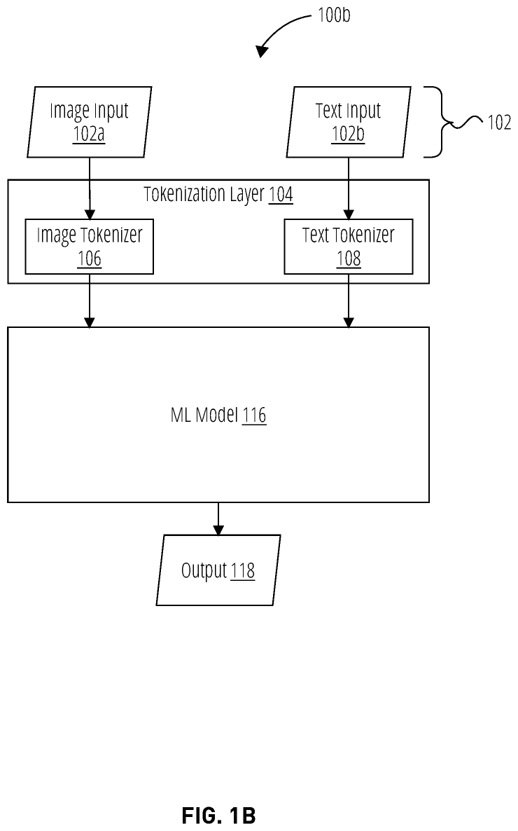

FIG. 1A and FIG. 1B illustrate non-limiting examples of multi-modal, machine learning (ML) models. These ML models can be fine-tuned, for example, based on user-submitted training sets. In both ML models, the multi-modal input (e.g., multi-modal input 102) includes image input 102a and text input 102b. Further, tokenization layer 104 converts the inputs to tokens. image tokenizer 106 converts image input 102a to image tokens, and text tokenizer 108 converts text input 102b to text tokens. According to certain non-limiting examples, image input 102a can be received in various formats. For example, image input 102a can be received using a Base64 (B64) image format. Additionally or alternatively, image input 102a can be received by providing a Uniform Resource Locator (URL) where the image is located.

In FIG. 1A, embedding layer 110 uses image embedding 112 to map the image tokens to image embeddings. Optionally, text embedding 114 can map the test tokens to text embeddings. The embeddings can then be applied to ML model 116 which generates output 118 in response to the applied inputs. According to certain non-limiting examples, ML model 116 is a large language model (LLM). For example, ML model 116 can be a pre-trained transformer, as discussed below. Further, ML model 116 can include a base model, which has pre-trained weights, and a fine-tuned portion that includes fine-tuned weights as disclosed below. Output 118 can be a text output, an image output, a multi-modal output, or a combination thereof. This disclosure primarily discusses the non-limiting example in which output 118 is text.

Fine-tuned model 100b in FIG. 1B is similar to fine-tuned model 100a in FIG. 1A, except the functions of embedding layer 110 has been integrated into ML model 116. This integration can make fine-tuning more efficient by allowing faster convergence and improving the quality of output 118. For example, the fine-tuning of fine-tuned model 100a can be performed by only fine-tuning weights in ML model 116, but an improved model can be generated by fine-tuning both embedding layer 110 and ML model 116. Fine-tuning both embedding layer 110 and ML model 116, however, can require more time than fine-tuning ML model 116 only.

According to certain non-limiting examples, image embedding 112 can be a contrastive language-image pre-training (CLIP) model. CLIP can be used to learn multi-modal representations to map images and their corresponding textual descriptions into a shared embedding space. Fine-tuned model 100a can use contrastive learning (e.g., unsupervised learning) in which the CLIP model learns to differentiate between similar and dissimilar image-text pairs. After training, the image encoder of CLIP can be used to generate image embeddings. These embeddings are vector representations of the content of the image in the shared space.

According to certain non-limiting examples, the fine-tuned model can include fine-tuned adapters that are added to a base model for efficiently adapting large pre-trained models to specific tasks without retraining the entire model. These adapters are small, task-specific modules inserted into pre-trained networks, allowing for parameter-efficient fine-tuning. Low-rank adapters (LoRA) represent one such approach where only a low-rank decomposition of weight matrices is updated, resulting in reduced computational requirements and memory usage relative to full fine-tuning (also referred to as end-to-end fine-tuning). LoRA can improve model performance for various downstream tasks without the need for full retraining, making it particularly useful in resource-constrained settings.

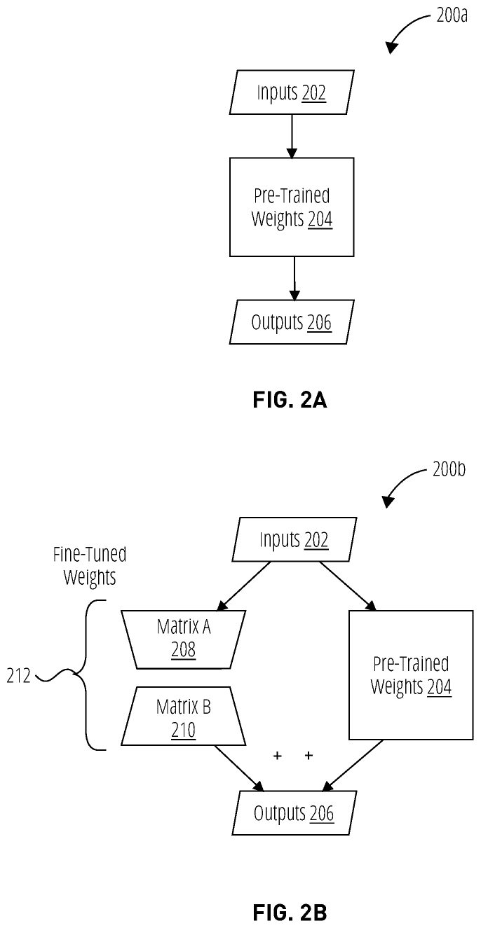

FIG. 2A and FIG. 2B illustrate an example of fine-tuning using low-rank adaptation (LoRA). FIG. 2A illustrates a layer/part of a neural network. For example, in a transformer architecture (e.g., transformer architecture 1000), pre-trained layer 200a can be a multi-head attention block (e.g., multi-head attention block 1022) or a feed forward block (e.g., feed forward block 1026). In pre-trained layer 200a, pre-trained weights 204 receive inputs 202 and generate outputs 206.

Low-rank adaptation (LoRA) is a method that introduces low-rank matrices into the model to adjust the output of each layer without significantly increasing the number of parameters, thereby providing efficient fine-tuning. Instead of fine-tuning all the weights in the model, LoRA introduces small learnable matrices into specific parts of the model (e.g., attention heads or feed-forward layers) and adapts only those matrices during fine-tuning. This approach can be parameter-efficient and computationally cheaper than full fine-tuning, making LoRA beneficial for fine-tuning very large models.

FIG. 2B illustrates using LoRA to fine-tune the pre-trained layer to generate fine-tuned layer 200b. Fine-tuned weights 212 include matrix A 208 and matrix B 210. For example, matrix A 208 is a dᵢₙₚᵤₜ×r matrix and matrix B 210 can be an r×dₒᵤₜₚᵤₜ matrix, where dᵢₙₚᵤₜ is the dimension of inputs 202, dₒᵤₜₚᵤₜ is the dimension of outputs 206, and r is the dimension of the reduced rank, which can be much smaller than both dᵢₙₚᵤₜ and dₒᵤₜₚᵤₜ. Thus, the number of fine-tuned weights 212 can be much smaller than the number of pre-trained weights 204. The fine-tuning may be improved by increasing the value of r, but increasing the value of r can also necessitate increasing the size of the training set used for fine-tuning. In FIG. 2B, outputs 206 is generated by summing the result from matrix B 210 with the result from pre-trained weights 204.

As described below, LoRA models are a non-limiting example of a fine-tuned model. A person of ordinary skill in the art will understand that the systems and methods disclosed herein can be implemented using other fine-tuned models. Where a LoRA model is used herein, another fine-tuned model can be used instead with straightforward modifications, as would be understood by the person of ordinary skill in the art.

According to certain non-limiting examples, a fine-tuned model (e.g., fine-tuned model 100a and fine-tuned model 100b) can be implemented on an inference engine that is distributed across multiple graphic processing units (GPUs) and/or multiple central processing units (CPUs). For example, an LLM such as GPT-3 can use multiple GPUs due to the size of the model of the model exceeding the memory capacity of a single GPU. To illustrate, GPT-3 has about 175 billion parameters, which uses around 350-GB of memory to store the model weights. Often high-performance GPUs (e.g., the NVIDIA A 100™ series GPUs) can have 40-GB or 80-GB of memory. For 80-GB GPUs, such as the NVIDIA A 100s™, five or more GPUs would be sufficient to store the entire model (e.g., 80-GB per GPU times five GPUs provides 400-GB, which is greater than the 350-GB occupied by the GPT-3 base model).

By increasing the number of 80-GB GPUs to seven, the combined amount of memory on the GPUs becomes 560-GB, of which 350-GB can be dedicated to storing the BM weights, 110-GB can be allocated to storing the LoRA weights, and 100-GB can be dedicated to KV cache. The number of weights for (and memory used by) a LoRA model can be more than a thousand times smaller than for the base model. Thus, 110-GB of the total GPU memory can be used to store the weights for hundreds of LoRA models (e.g., 500-LoRA models). Further, 100-GB of memory for KV cache can be sufficient to run multiple queries in parallel. Assuming that about 2.5-GB of KV cache is needed for a single query with 1,024 tokens, 100-GB of KV cache is sufficient to run forty queries in parallel. This example is non-limiting and is provided to illustrate how the number of LoRA models and the number of parallel queries can scale based on the amount of memory allocated to KV cache and allocated to storing LoRA weights. Like the BM weights, the LoRA weights for a given model are distributed among the GPUs. As discussed below, the LoRA weights can correspond to respective layers in a neural network. Thus, the LoRA weights for a given layer can be in the same GPU as the BM weights for that layer.

According to certain non-limiting examples, the fine-tuned model is trained using distributed training. Further, according to certain non-limiting examples, the fine-tuned model is trained using layer and tensor parallelism during the training process.

LoRA can be used to efficiently fine-tune large pre-trained models, especially when adapting them to new tasks or domains. As discussed above, LoRA is used to reduce the number of parameters that need to be updated during fine-tuning by introducing low-rank parameterizations. This method is particularly useful when dealing with large models that are computationally expensive to retrain. A large model (e.g., a transformer, deep neural network) can be pre-trained on a massive amount of data and have learned generalizable representations. These models have a large number of parameters, which are computationally expensive to fine-tune for specific tasks. Instead of fine-tuning the entire model, LoRA introduces low-rank matrices that are added to certain layers of the model. These low-rank matrices approximate changes needed for adapting the model to new tasks.

LoRA has many advantages. LoRA can make fine-tuning becomes more efficient because only a small number of parameters are modified. LoRA can be more computationally efficient. By reducing the number of trainable parameters, LoRA reduces the overall computational cost of fine-tuning. LoRA can provide better generalization. By keeping the majority of the model fixed, LoRA allows the pre-trained model's generalization capabilities to be retained while adapting to the new task. LoRA can provide improved memory efficiency because it requires less memory during fine-tuning since fewer parameters need to be stored and updated.

LoRA is a non-limiting example of a method that can be used for fine-tuning, and other fine-tuning methods can be used. Other non-limiting examples of methods for fine-tuning include, but are not limited to, full fine-tuning (also referred to as end-to-end fine-tuning), adapter-based fine-tuning, partial fine-tuning (freezing some layers), a combination of prompt engineering and fine-tuning, parameter-efficient fine-tuning (PEFT), multi-task learning, reinforcement learning, regularization techniques, and adding task-specific layers.

In full fine-tuning, all parameters of the model are fine-tuned using a task-specific dataset. For example, a pre-trained model undergoes additional training using a new, task-specific dataset. This allows the model to adjust all of its parameters to better solve the specific task.

Adapters are small modules that are combined with or inserted into a pre-trained model to allow task-specific customization without modifying the entire model. These adapters are trained while the rest of the model's parameters remain frozen. For example, adapters can be lightweight neural networks (e.g., small feedforward neural networks) that are inserted into the layers of the model. Only the parameters of the adapter are updated during fine-tuning, while the rest of the model (usually the transformer layers) remains frozen. This makes the fine-tuning process computationally efficient.

Another approach for fine-tuning is to unfreeze only certain parts of the model and fine-tune those layers while keeping the rest of the model frozen. This can save computational resources and prevent overfitting, e.g., when the dataset is small. Partial fine-tuning can be realized by selectively unfreezing some of the model's layers, such as the top few transformer layers (e.g., the last one to two layers of the transformer network). These unfrozen layers can capture high-level, task-specific features, while the lower layers capture more general language knowledge. Only the unfrozen layers are trained on your task-specific data, and the rest of the model's parameters are frozen (i.e., they are not updated during backpropagation).

According to certain non-limiting examples, fine-tuning can also be combined with prompt engineering techniques. Prompt engineering involves designing specific prompts that can guide the model to perform a given task effectively. For example, if you want the model to answer questions, you could prepend each input with “Answer the following question:” or “Summarize the text below.” After selecting one or more prompt formulations, the model can be fine-tuned on the selected prompts to improve its performance for the specific task.

There are other methods of fine-tuning. Parameter-efficient fine-tuning (PEFT) minimizes the number of parameters that need to be updated during fine-tuning, making it efficient for resource-constrained scenarios. In multi-task learning, the model is trained on multiple related tasks simultaneously to improve generalization and capture common patterns across different domains. Reinforcement learning uses reward systems to guide the model's learning process and fine-tune its behavior toward optimal decision-making in specific scenarios. Regularization techniques such as dropout or L1/L2 regularization can be used to prevent overfitting and improve model stability during fine-tuning. In instruction fine-tuning, the model is trained using explicit instructions and examples to guide its responses for a particular task. Prompt engineering uses carefully crafted prompts to steer the LLM toward generating the desired output for the specific task. Few-shot learning fine-tunes the model with a limited number of examples to adapt to new tasks quickly.

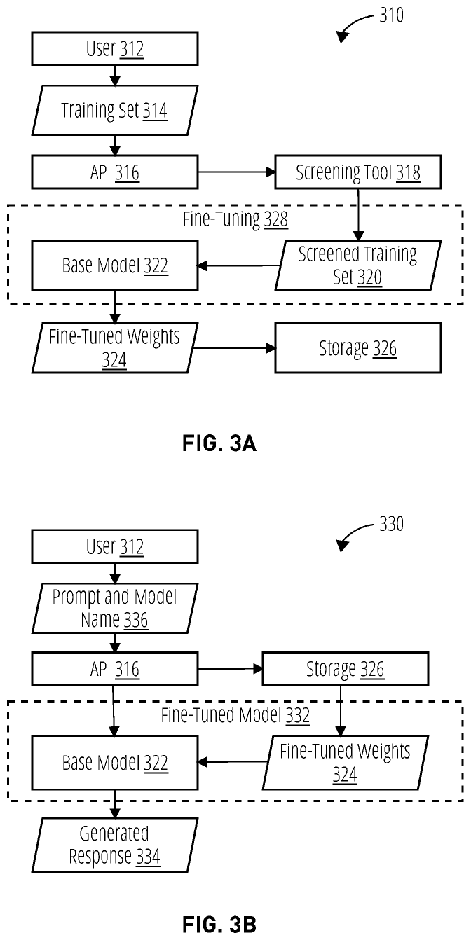

FIG. 3A illustrates a process flow for fine-tuning an ML model 310 in which a generative response engine is fine-tuned to obtain a fine-tuned model, such as fine-tuned model 100a and fine-tuned model 100b. User 312 provides training set 314, which includes inputs (e.g. images and text prompt) associated with desired outputs for a particular task.

For example, the ML model can be trained to interpret radiology images (e.g., x-ray computer aided tomography images or magnetic resonance images) to screen for health problem, such as flagging possible tumors or arterial blockages. In this case, the inputs could include medical images and a description of what issues the image are being screened for. The desired outputs associated with these inputs can be the descriptions from medical professionals or what issues were detected (and not detected) in the images of the inputs.

An application programming interface (e.g., API 316) can mediate the user's interactions with the ML model. API 316 receives training set 314 from user 312 and uses screening tool 318 to screen training set 314 to ensure it satisfies various criteria, such as one or more safety criteria. For example, safety criteria can include screening images in training set 314 to exclude images and content related to violence, nudity, people, and minors. According to certain non-limiting examples, images that do not meet the safety criteria are removed from the training data, and the entire job is halted if too many unsafe images are detected.

After excluding content in training set 314 that fails the screening criteria of screening tool 318, the remaining content is passed from screening tool 318 to fine-tuning 328 as screened training set 320. In fine-tuning 328, base model 322 is held constant, and the fine-tuning weights are adjusted to optimize an objective function. Upon convergence of the objective function, the resulting weights are stored as fine-tuned weights 324 in storage 326. API 316 can provide user 312 a name for the fine-tuned model, and this name can be used to access the fine-tuned model and to fetch fine-tuned weights 324 from storage 326.

FIG. 3B illustrates a process flow for using a fine-tuned ML model 330. After the ML model has been trained, user 312 provides calling information (e.g., prompt and model name 336) that identifies the fine-tuned model and provides a prompt to which the ML model responds. This calling information can be included in an API call to API 316, for example. API 316 uses the model name to fetch fine-tuned weights 324 from storage 326, and fine-tuned model 332 includes the combination of base model 322 and fine-tuned weights 324. The prompt from the calling information is then applied to fine-tuned model 332 to generate generated response 334.

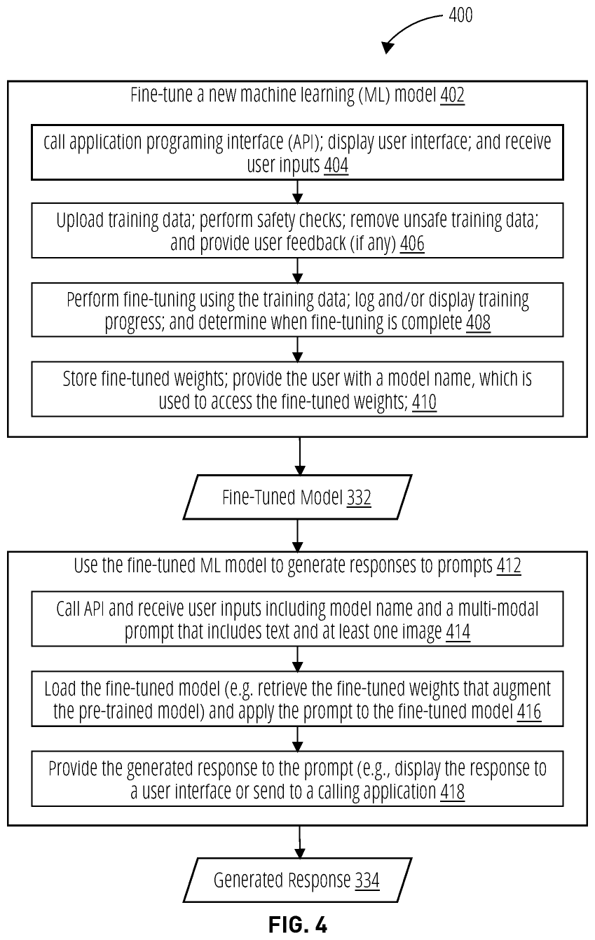

FIG. 4 illustrates an example method 400 for training and using a fine-tuned ML model. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes fining-tuning a new machine learning (ML) model at process 402. For example, API 316 illustrated in FIG. 3A may receive training set 314 from user 312, and, after screening the training set, screened training set 320 is used to fine-tune a new machine learning (ML) model. Process 402 can include steps 404-410.

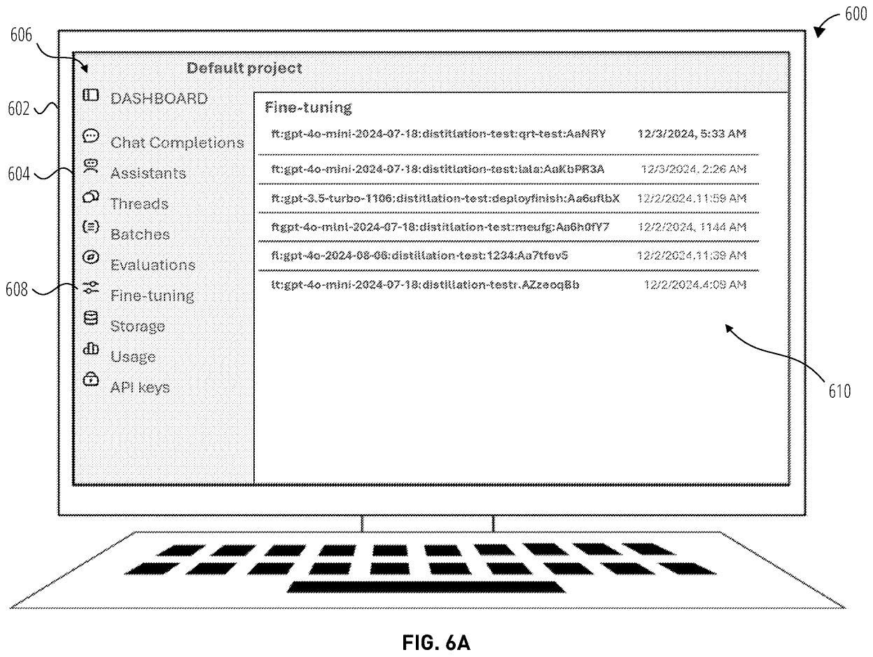

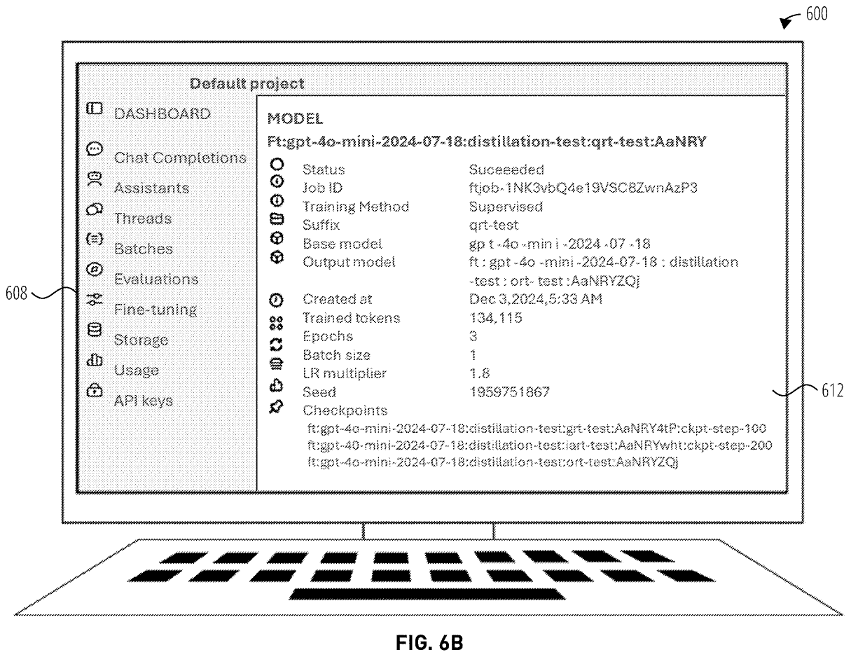

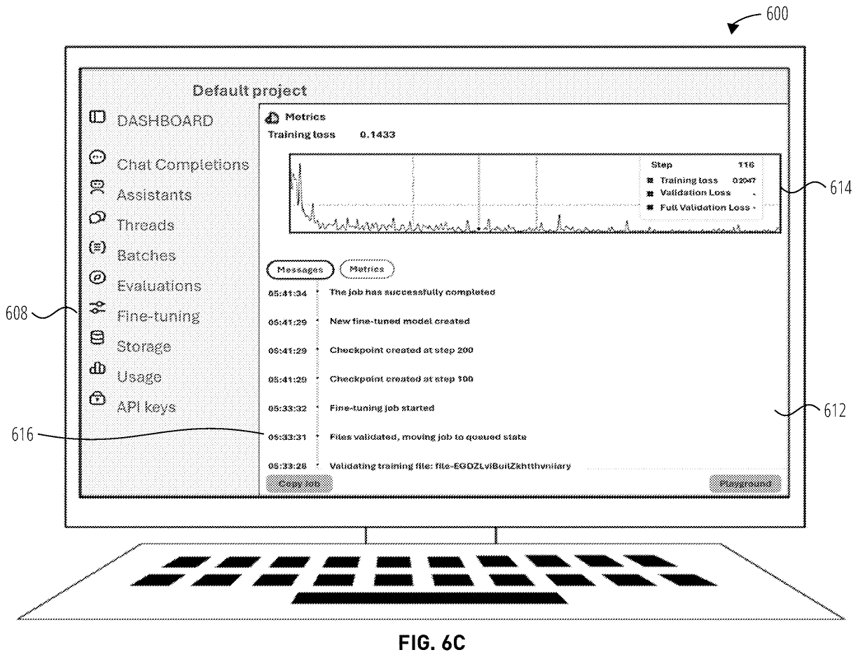

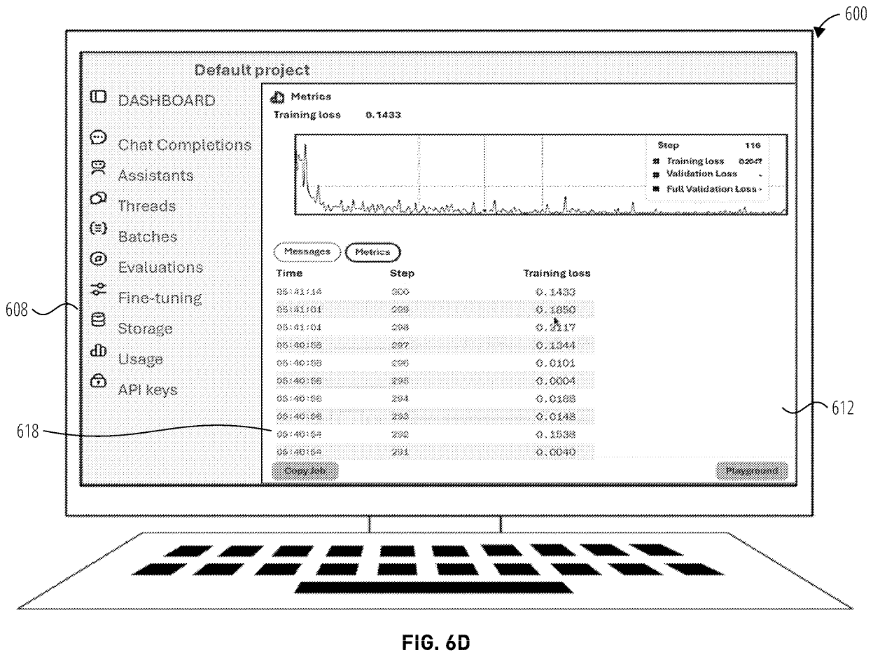

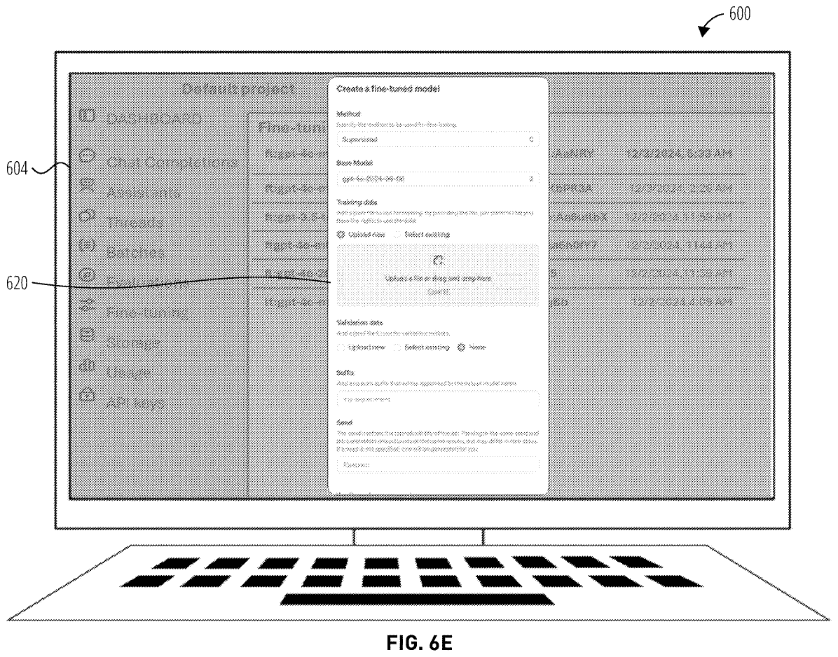

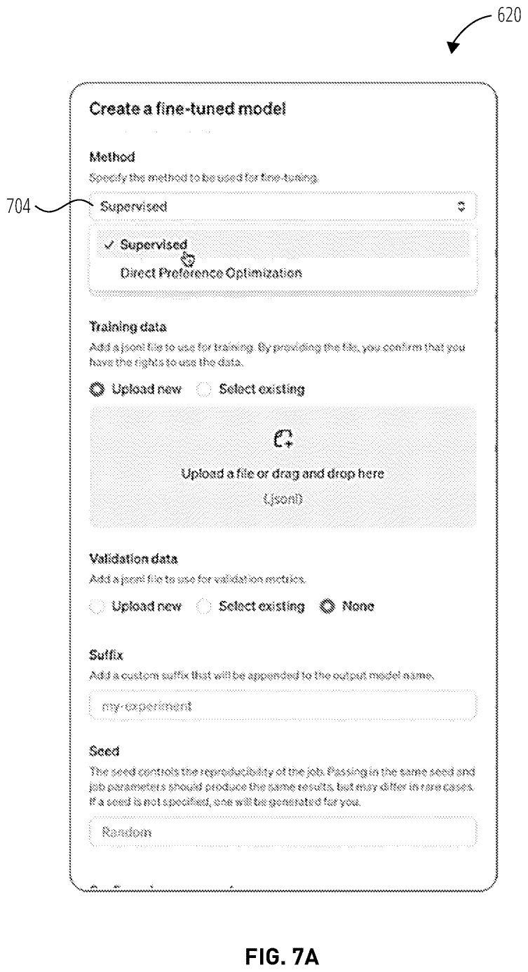

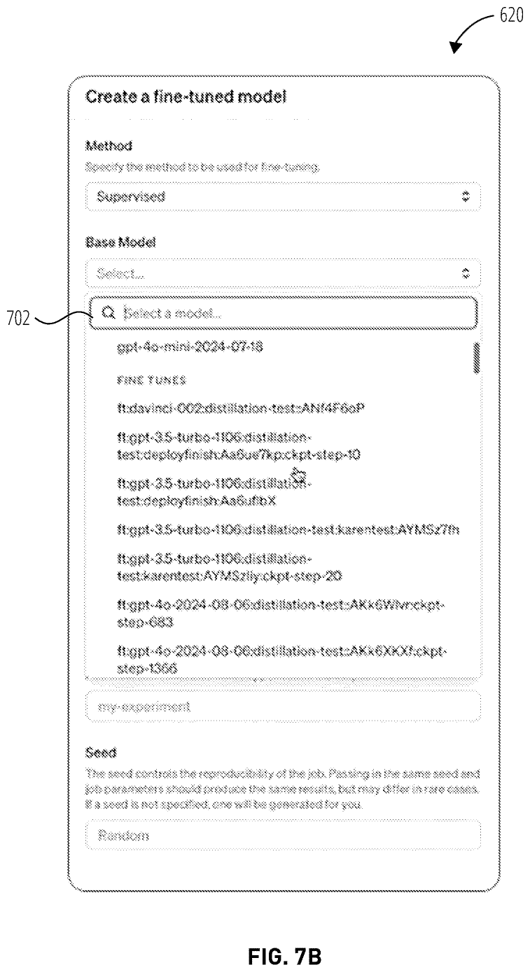

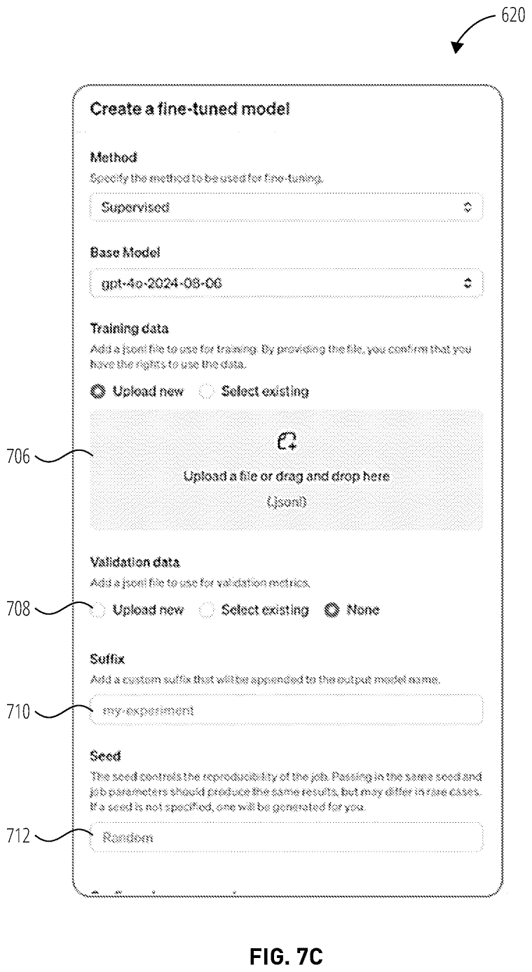

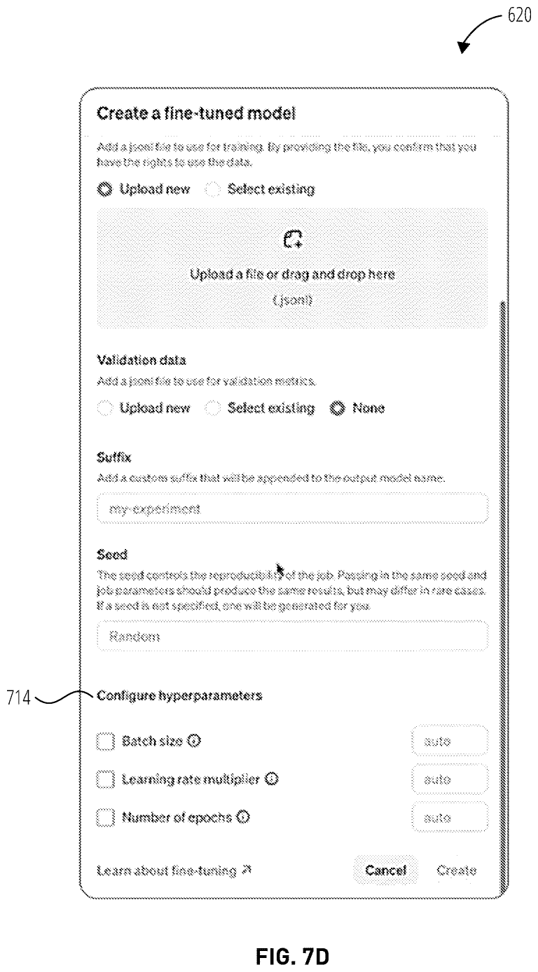

According to some examples, step 404 of the method includes calling the application programming interface (API). Further, step 404 of the method can include displaying a user interface (UI), such as shown in FIG. 6E and FIGS. 7A-7D, and receiving via the UI various user inputs. For example, the API 316 illustrated in FIG. 3A may be called, resulting in the UI being displayed to receive the user inputs (e.g., training set 314).

According to some examples, step 406 of the method includes uploading training data. Further, step 406 of the method can include performing safety checks and removing unsafe training data. Optionally, step 406 of the method can include providing user feedback (if any). For example, API 316 illustrated in FIG. 3A is used to upload training data. Further, screening tool 318 illustrated in FIG. 3A may perform safety checks and remove unsafe training data. API 316 can then provide user feedback (if any). For example, when the number of unsafe images exceeds a threshold, the training set can be rejected and a message can be sent via API 316 to user 312 indicating that training set 314 has been rejected.

According to some examples, step 408 of the method includes performing fine-tuning using the training data; logging and/or displaying the training progress; and determining when fine-tuning is completed. For example, fine-tuning 328 illustrated in FIG. 3A may perform fine-tuning using the training data. Further, API 316 can log training progress, and the UI can display training progress including when the fine-tuning is complete.

According to some examples, step 410 of the method includes storing fine-tuned weights and providing the user with a model name, which is used to access the fine-tuned weights. For example, the storage 326 illustrated in FIG. 3A may store the fine-tuned weights. Further, API 316 can send a message to the user indicating the model name, which is later used to access the fine-tuned weights.

According to some examples, process 412 of the method includes using the fine-tuned ML model to generate responses to prompts. For example, the API 316 illustrated in FIG. 3B may receive prompt and model name 336 from user 312. The model name is then used to fetch fine-tuned weights 324 from storage 326. Fine-tuned model 332 includes the combination of base model 322 and fine-tuned weights 324, which augment the base model 322. The prompt from prompt and model name 336 is then applied to fine-tuned model 332 to generate a response (e.g., generated response 334). Process 412 can include steps 414-418.

According to some examples, step 414 of the method includes calling the API, and The API receives user inputs, which can include the model name and a multi-modal prompt that includes a text input and at least one image input. For example, the API 316 illustrated in FIG. 3A may be accessed via an API call, and API 316 can receive user inputs, including the model name and a multi-modal prompt (e.g., prompt and model name 336).

According to some examples, step 416 of the method includes loading the fine-tuned model (e.g., by loading the fine-tuned weights from storage 326 to augment the pre-trained model). Step 416 of the method can also include applying the prompt to the fine-tuned model. For example, the fine-tuned model 332, illustrated in FIG. 3B, can be instantiated by loading fine-tuned weights 324 from storage 326 to augment base model 322, thereby providing fine-tuned model 332. Then the prompt and model name 336 can be applied to fine-tuned model 332.

According to some examples, step 418 of the method includes providing the response that is generated based on the prompt (e.g., displaying the response from the fine-tuned model in a user interface or sending the response to an application that called the API). For example, the API 316 illustrated in FIG. 3A may provide generated response 334 to user 312. Generated response 334 can then be displayed in the UI, or generated response 334 can be sent to a calling application (i.e., the application that sent the API call).

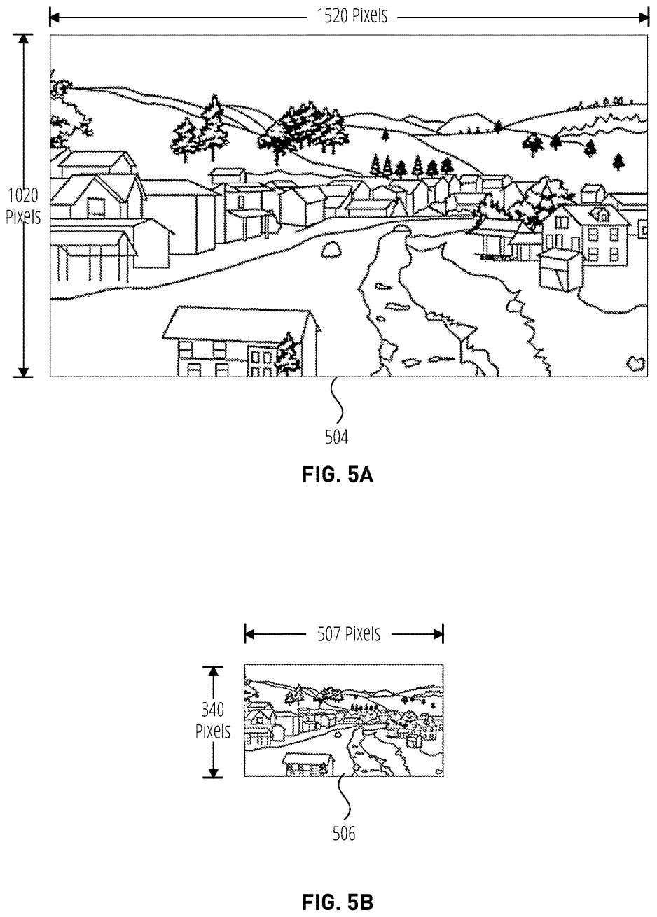

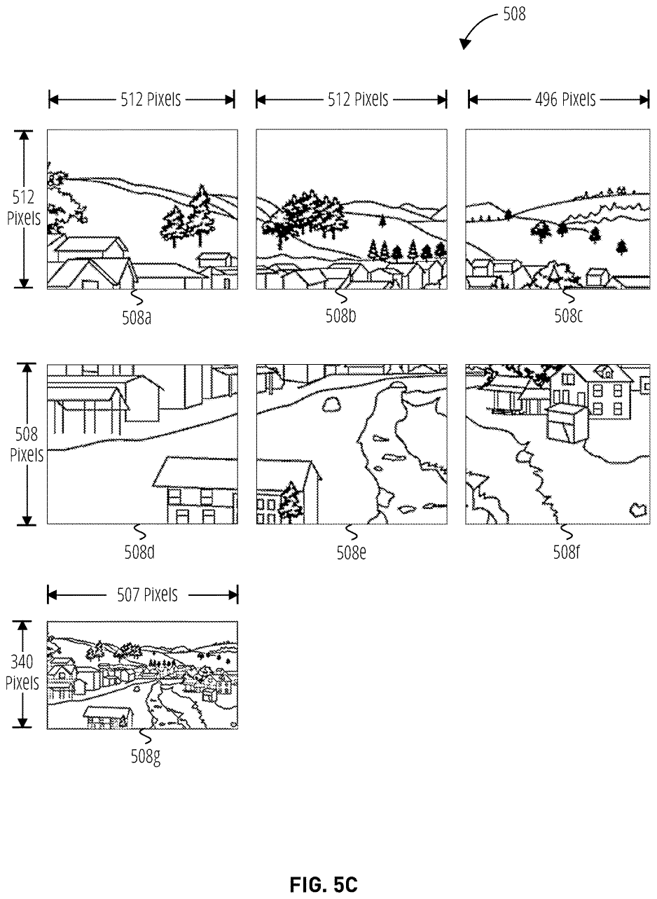

FIGS. 5A-5C illustrate examples of preprocessing images in preparation for the images to be used to fine-tune the ML model. According to certain non-limiting examples, the ML model can accept images with a maximum size of N×M pixels. As a non-limiting example, the maximum image size is assumed to be 512×512 pixels (i.e., N=512 pixels and M=512 pixels). When the user's image exceeds the maximum image size, the image can be resized to be less than or equal to the maximum image size, as illustrated in FIG. 5B. Alternatively, an image exceeding the maximum image size can be subdivided into tiles that each are less than or equal to the maximum image size, as illustrated in FIG. 5C.

FIG. 5A shows original image 504 that is 1020×1520 pixels, exceeding the maximum image size of 512×512 pixels.

One way to enforce the maximum image size restriction is to resize images by shrinking them until they are less than or equal to the maximum image size. This can be performed by downsampling, low pass filtering, averaging blocks of pixels, etc. FIG. 5B shows an example in which resized image 506 is generated from original image 504 by resizing from 1020×1520 pixels to 340×507 pixels. This resizing is performed by averaging each 3×3 block of pixels in original image 504 to obtain respective pixels in resized image 506, thereby reducing the size of the image by a factor of three from 1020×1520 pixels to 340×507 pixels.

FIG. 5C shows an example in which original image 504 is subdivided into tiles 508. Tiles 508 includes tile 508a, tile 508b, tile 508c, tile 508d, tile 508e, and tile 508f, which represent different areas within original image 504. Each of these tiles is less than or equal to the maximum image size. Additionally, tiles 508 can include tile 508g, which is identical to resized image 506. When tiles 508 are applied to the ML model and/or image embedding 112, positional encodings can be used to preserve information of the spatial relations among the tiles.

FIGS. 6A-6E show various views of user interface 604 that can be used to generate new fine-tuned models and access existing fine-tuned models. FIG. 6A shows computing device 600 that includes display 602. User interface 604 (also referred to as UI) is displayed on display 602, and user interface 604 include UI main menu 606. By selecting fine-tuning icon 608 in UI main menu 606, the UI displays lists of fine-tuned models 610.

FIG. 6B shows user interface 604 after selecting a fine-tuned model from the existing list of fine-tuned models 610. User interface 604 includes model report 612 which includes various parameters, messages and metric related to the fine-tuning process. These can include the status of the fine-tuning, such as whether fine-tuning has succeeded. Further, this can include the job ID, the training method, the base model, the output model, and various other details related to training the fine-tuned model.

FIG. 6C shows model report 612 after scrolling farther down the window. The metrics shows in FIG. 6C include training-loss plot 614, which shows the value of the training loss (vertical axis) as a function of time/step (horizontal axis). When the message button is selected, model report 612 also shows a series of messages 616 and their corresponding time stamps. According to certain non-limiting examples, the metric can include or use evaluations applied to the fine-tuned model. Further, the evaluations can be applied using validation data. A metric based on the evaluations using validation data can be calculated after each epoch or after predefined evaluation criteria are satisfied (e.g., the epoch modulo the integer N is zero). Examples of metrics can include the training loss (e.g., the value of the loss/objective function used to train the model). Additionally or alternatively, part of the training data can be separated out to use as validation, and the metrics can be based on the relation/matching between the response predicted by the model for the input of the validation data and the corresponding label/output of the validation data.

Various evaluation metrics can be used. Examples of evaluation metrics that can use validation data include, but are not limited to, an exact-match metric, an F1 score, a BERTScore metric. The BERTScore metric can use deep semantic similarity instead of exact matches to capture meaning beyond word-level similarity. The exact-match metric can be used for factual question answering (QA) tasks by measuring whether the model's response matches a reference answer. The F1 score can be used for QA tasks and retrieval tasks by measuring overlap between predicted and actual text. Other metrics can include, but are not limited to, a bias benchmark for question answering, accuracy, precision (e.g., measures false positives), sensitivity (e.g., measures false negatives), receiver operating characteristic-area under curve (ROC-AUC), intersection over union (IoU) (e.g., measures how much predicted bounding boxes overlap with ground truth), mean average precision (e.g., measures how well the model detects objects at various intersection over union (IoU) thresholds. According to certain non-limiting examples, the evaluation metrics can determine a semantic similarity between the output in the validation data and the generated response by the model. Semantic similarity measures how closely related two pieces of information are in meaning. Semantic similarity can be used for both text and vision tasks. In vision tasks, Semantic similarity can be based on feature embeddings that compare images or objects based on their high-level attributes rather than pixel-level differences. For example, semantic similarity can be represented by cosine similarity, Euclidean distance, CLIP similarity, triplet loss, or Siamese networks. The cosine similarity can measure the angle between feature vectors. Euclidean distance can measure the straight-line distance between embeddings. CLIP similarity: Compares text and image embeddings. triplet loss and Siamese networks can be used to learn embeddings where similar objects are closer in the latent space.

FIG. 6D shows that when the metric button is selected-instead of the message button metric values 618 are displayed for a selected metric together with their corresponding step number and timestamp.

User interface 604 can also be used to create a new fine-tuned model. FIG. 6E shows an example of a popup window that appears in user interface 604. Create-a-fine-tuned-model interface 620 provides users with various options for the base model, the fine-tuning method, and other parameters that the user can choose when creating a fine-tuned model.

FIGS. 7A-7D show close-up views of create-a-fine-tuned-model interface 620 for various stages of defining the new fine-tuned model. FIG. 7A shows create-a-fine-tuned-model interface 620 being used to select a fine-tuning method using dropdown menu 704.

FIG. 7B shows using text entry 702 in create-a-fine-tuned-model interface 620 to select a base model. When LoRA is used, the base model can be base model 322 that includes pre-trained layer 200a, which remain unchanged during fine-tuning.

FIG. 7C shows create-a-fine-tuned-model interface 620 after having selected the method for fine-tuning and the base model. Drag-and-drop field 706 can be used to provide the training set that is used for fine-tuning. The training set includes both text and image inputs, as disclosed above. An API can provide different ways for user to submit these images. Radio buttons 708 provide users the option of adding a file that is used for validation. Text entry box 710 allows users to customize the model name, such as providing custom nomenclature or explanatory phrases to label the resulting fine-tuned model. Text entry box 712 allows the user to specify a seed for the fine-tuning process or allow the seed to be randomly selected.

According to certain non-limiting examples, users can submit images as URLs or as base 64 encoded strings. To ingest the images, the API can perform various processing steps such as checking to ensure that a provides URL is actually pointing at a proper image location, making sure that the images are not corrupted, ensuring that the images are in a format that can be ingested, processing images that are larger than the maximum image size (e.g., by resizing the images or subdividing the image into tiles), etc.

FIG. 7D shows that by scrolling down, create-a-fine-tuned-model interface 620 includes various hyperparameter options 714 that can be selected by the user. Hyperparameters are ML settings or configurations that influence how a machine learning (ML) model learns during training. These hyperparameters can influence aspects like the learning process, the speed of learning, and the structure of the mode. Examples of hyperparameters can include learning rate, batch size, number of epochs, weight decay (e.g., L2 regularization), gradient clipping, warm-up steps, max token length, early stopping criteria, model layer freezing, and dropout rate.

The learning rate hyperparameter controls how much the model's weights are adjusted in response to the error signal (gradient) during each step of training. For example, a high learning rate can cause the model to converge too quickly or “overshoot” optimal solutions, while a low learning rate can lead to slow learning and might get stuck in local minima.

The batch size hyperparameter refers to the number of training samples processed before the model's internal parameters are updated. For example, larger batch sizes can lead to more stable training and faster convergence, but they require more memory. Smaller batch sizes can introduce more noise but might lead to better generalization.

The number of epochs (training steps) hyperparameter controls how many times the entire training dataset is passed through the model. For example, more epochs allow the model to learn more from the dataset, but too many epochs can lead to overfitting (where the model memorizes the training data rather than generalizing well).

The weight decay hyperparameter controls a regularization technique that helps prevent the model from overfitting by penalizing large weights. It adds a penalty to the loss function based on the magnitude of the model's parameters. This hyperparameter can reduce overfitting by encouraging the model to find simpler solutions. The gradient clipping hyperparameter limits the size of gradients during backpropagation to avoid the issue of exploding gradients (when gradients grow too large and cause instability in training). For example, gradient clipping can help maintain training stability, particularly when using large models or when the model is fine-tuned with very large datasets.

The warm-up period hyperparameter refers to the initial number of steps where the learning rate gradually increases from a very small value to the initial learning rate. For example, this hyperparameter can help stabilize training in the early stages and avoids the model's weights being updated too aggressively when the model is still “getting its bearings.”

The max token length hyperparameter refers to the maximum number of tokens that the model will process in a single training example or during inference. For example, this hyperparameter can increase the maximum token length allows the model to handle longer sequences, but this also requires more memory and computation. If set too low, this hyperparameter can cut off important context in the input.

The early stopping criteria hyperparameter is used to stop the training early if the model's performance (e.g., validation loss) doesn't improve for a specified number of steps or epochs. For example, this hyperparameter can prevent overfitting and reduce unnecessary computation by halting training when it no longer results in better performance.

The model layer freezing hyperparameter can be used to control freezing certain layers of the model, preventing their weights from being updated during training. For example, freezing early layers helps speed up training by reducing the number of parameters that need to be updated, and it can help prevent overfitting on small datasets by retaining some of the pre-learned general knowledge.

The dropout hyperparameter refers to a regularization technique where random neurons are dropped (e.g., set to zero) during training to prevent overfitting. The dropout rate is the probability that a given neuron will be dropped. Dropout prevents the model from becoming too reliant on any single neuron, thereby promoting generalization.

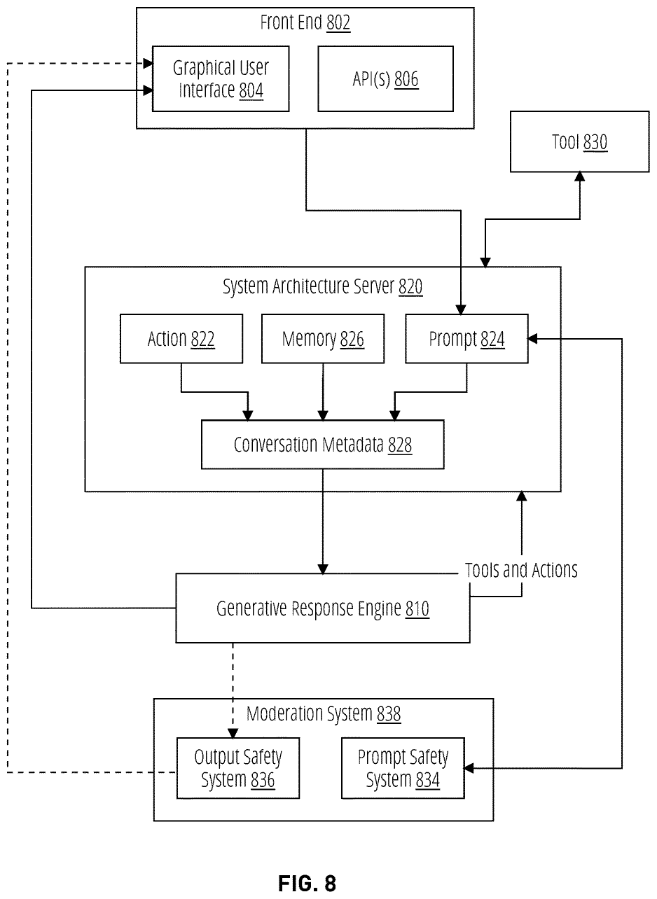

FIG. 8 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 810 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 810 through the front end 802. The front end 802 serves as the interface and intermediary between the user and the generative response engine. It encompasses the graphical user interface 804 and Application programming interfaces (APIs) such as API 806 that facilitate communication, input processing, and output presentation. Generally, users interact through a graphical user interface 804 that often includes a conversational interface, and applications interact through the API 806, but this is not a requirement.

The graphical user interface 804 is the platform through which users interact with the generative response engine 810. It can be a web-based chat window, a mobile application, or any interface that supports data input and output. The graphical user interface 804 facilitates a conversation between the user and the generative response engine, as the user provides prompts in the graphical user interface 804 to which the generative response engine responds and presents those responses in the graphical user interface 804. In some embodiments, graphical user interface 804 presents a conversational interface, which has attributes of a conversation thread between a user account and generative response engine 810.

The graphical user interface 804 is configured to perform input handling, context management, and output presentation. The type of inputs that can be received can be relative to the specifics of the generative response engine 810. But even when a model doesn't directly accept certain types of inputs, the front end 802 might be able to receive different types of inputs, which can be converted to inputs that are accepted by the generative response engine 810. For example, a language model is generally configured to accept text, but the front end 802 can accept voice and convert it to text or accept an image and create a textual representation.

The graphical user interface 804 is also configured to maintain the context of the conversation, which allows for coherent and relevant responses. For example, the graphical user interface 804 is responsible for providing the conversation thread and other relevant context accessible to the front end 802 to the generative response engine along with the specific prompt to the generative response engine. In an example, a conversation between the user account and the generative response engine 810 can have taken several turns (prompt, response, prompt, response, etc.). When the user account provides a further prompt, the graphical user interface 804 can provide that prompt to the generative response engine in the context of the entire conversation.

In another example, the front end 802 might have access to a memory 826 where facts about the user account have been stored. In some embodiments, these facts can have been identified as facts worth storing by the generative response engine and the front end 802 has stored these facts at the direction of the generative response engine. Accordingly, these facts can be provided to the generative response engine 810 along with a user-provided prompt so that the generative response engine has access to these facts when generating a response.

In another example, the graphical user interface 804 might be configured to provide a system prompt along with a user-provided prompt. A system prompt is hidden from the user account and is used to set the behavior and guidelines for the generative response engine. It can be used to define the AI's persona, style, and constraints.

The graphical user interface 804 is also configured to display the responses from the generative response engine, which might include text, code snippets, images, or interactive elements.

In some embodiments, the generative response engine 810 can provide instructions to the front end 802 that instruct the graphical user interface 804 about how to display some of the output from the generative response engine. For example, the generative response engine can direct the graphical user interface 804 to present code in a code-specific format, or to present interactive graphics, or static images. In other examples, the generative response engine can direct the graphical user interface 804 to present an interactive document editor where the graphical user interface 804 can be presented with the document editor so that the user account and the generative response engine can collaborate on the document. In some embodiments, the generative response engine 810 can provide instructions to the front end 802 to record facts in a personalization notepad. Accordingly, the graphical user interface 804 does not always display all of the output of the generative response engine.

As noted above, the front end 802 can also provide one or more application programming interfaces (API(s)) 806. APIs enable developers to integrate the generative response engine's capabilities into external applications and services. They provide programmatic access to the generative response engine, allowing for customized interactions and functionalities.

The APIs 806 can accept structured requests containing prompts, context, and configuration parameters. For example, an API can be used to provide prompts and divide the prompt into system prompts and user prompts. In some embodiments, the APIs 806 can provide specific inputs for which the generative response engine 810 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 810 might be trained to interpret. For example, the moderation API can take advantage of the generative response engine's content moderation decision-making. In the case of the moderation API and others, the API might give access to services other than the generative response engine. For example, the moderation API might be an interface to moderation system 838, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 804 and the APIs 806 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 802 and generative response engine 810 is a system architecture server 820. The function of system architecture server 820 is to manage and organize the flow of data among key subsystems, enabling the generative response engine 810 to generate responses that are contextually relevant, accurate, and enriched with additional information as required.

Action 822 facilitates auxiliary tasks that extend beyond basic text generation. In some embodiments, action 822 can be actions that correspond to an API 806. In some embodiments, action 822 can be agentic actions that the generative response engine 810 decides to take to carry out a user's intent as described in the prompt.

Prompt 824 is the request or command provided by the user account through front end 802. In some embodiments, prompt 824 can be further supplemented by a system prompt and other information that might be included by graphical user interface 804 or API 806. In some embodiments, prompt 824 can even be modified or enhanced by generative response engine 810 as addressed further below. Additionally, as the user account provides prompts and generative response engine 810 provides responses, a conversation thread forms. As the user account provides a new prompt, this is appended to the overall conversation and added to prompt 824. Thus, a user account might think of a first user-provided message as a first prompt and a second user-provided message as a second prompt, and so on, but prompt 824 as perceived by generative response engine 810 can include a thread of user-provided messages and responses from generative response engine 810 in a multi-turn conversation. Generally, prompt 824 will include an entire conversation thread, but in some instances, prompt 824 might need to be shortened if it exceeds a maximum accepted length (generally measured by a number of tokens).

System architecture server 820 can also route prompts and response through moderation system 838, which can be separate or part of system architecture server 820. In some embodiments, prompts are provided to prompt safety system 834 before being provided to generative response engine 810. Prompt safety system 834 is configured to use one or more techniques to evaluate prompts to ensure a prompt is not requesting generative response engine 810 to generate moderated content. In some embodiments, prompt safety system 834 can utilize text pattern matching, classifiers, and/or other AI techniques.

Since prompts can evolve over time through the course of a conversation, consisting of prompts and responses, prompts can be repeatedly evaluated at each turn in the conversation.

Memory 826 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 810 when generative response engine 810 identifies a fact or data that it determines should be saved in memory because it might be useful in later conversations or sessions.

Conversation metadata 828 can aggregate data points relevant to the conversation, including user prompt 824, action 822, and memory 826. This consolidated information package serves as the input for generative response engine 810. Conversation metadata 828 can label parts of a prompt as user provided, generative response engine provided, a system prompt, memory 826, data from action 822 or tool 830 (addressed below).

The generative response engine is the core engine that processes inputs (from system architecture server 820) and generates outputs. In some embodiments, the generative response engine is a Generative Pre-trained Transformer (GPT), but it could utilize other architectures.

A core feature of the generative response engine 810 is to generate content in response to prompts. When the generative response engine 810 is a GPT, it is configured to receive inputs from front end 802 that provide guidance on a desired output. The generative response engine can analyze the input and identify relevant patterns and associations in the data, and it has learned to generate a sequence of tokens that are predicted as the most likely continuation of the input. The generative response engine 810 generates responses by sampling from the probability distribution of possible tokens, guided by the patterns observed during its training. In some embodiments, the generative response engine 810 can generate multiple possible responses before presenting the final one. The generative response engine 810 can generate multiple responses based on the input, and these responses are variations that the generative response engine 810 considers potentially relevant and coherent.

In some embodiments, the generative response engine 810 can evaluate generated responses based on certain criteria. These criteria can include relevance to the prompt, coherence, fluency, and sometimes adherence to specific guidelines or rules, depending on the application. Based on this evaluation, the generative response engine 810 can select the most appropriate response. This selection is typically the one that scores highest on the set criteria, balancing factors like relevance, informativeness, coherence, and content moderation instructions/training.

In some embodiments, an instruction provided by an API 806, a system prompt, or a decision made by generative response engine 810 can cause the generative response engine 810 to interpret a prompt and re-write it or improve the prompt for a desired purpose. For example, generative response engine 810 can determine to take a prompt to make a picture and enhance the prompt to yield a better picture. In these instances, generative response engine 810 can generate its own prompts, which can be provided to a tool 830 or provided to generative response engine 810 to yield a better output response than the original prompt might have.

The generative response engine 810 can also do more than generate content in response to a prompt. In some embodiments, the generative response engine 810 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ) , and the generative response engine can utilize a decision boundary to recognize that it needs to plan steps to locate the third-party service, contact the third-party service, and interact with the third-party service to complete the task and then report back to the user that the action has been completed.

When generative response engine 810 determines that it should take an agentic action on behalf of the user or it should call a tool to aid in providing a quality response to the user account, the generative response engine 810 might call a tool 830 or cause an action 822 to be performed. As indicated above, tools 830 can include internet browsers, editors such as code editors, other AI tools etc. Actions 822 are actions that the generative response engine 810 can cause to be performed, perhaps using tool 830. As used herein actions 822 should be considered to cover a broad array of actions that generative response engine 810 can perform with or without tools 830. Tools 830 are considered to cover a wide variety of services and software that encompass tools such as a computer operating system such that the generative response engine 810 can control the computer operating system on the user's behalf, to robotic actuators, to search browsers and specific applications.

Additionally, the generative response engine 810 can also generate portions of responses that are not displayed to the user. For example, the generative response engine 810 can direct the front end 802 to provide specific behaviors, such as directions for how to present the response from the generative response engine 810 to the user account. In another example, the generative response engine 810 can provide response portions dictated by an API, where portions of the response to the API might be for the consumption of the calling application but not for presentation to the end user.

In some embodiments, the output of generative response engine can be further analyzed by output safety system 836. While generative response engine 810 can perform some of its own moderation, there can be instances where it is desired to have another service review outputs for compliance with the moderation policy. The use of dashed lines in FIG. 8 differentiates a path using output safety system 836 and not using output safety system 836.

While FIG. 8 shows responses being provided back to front end 802 directly, in some embodiments, the responses might be returned by way of system architecture server 820.

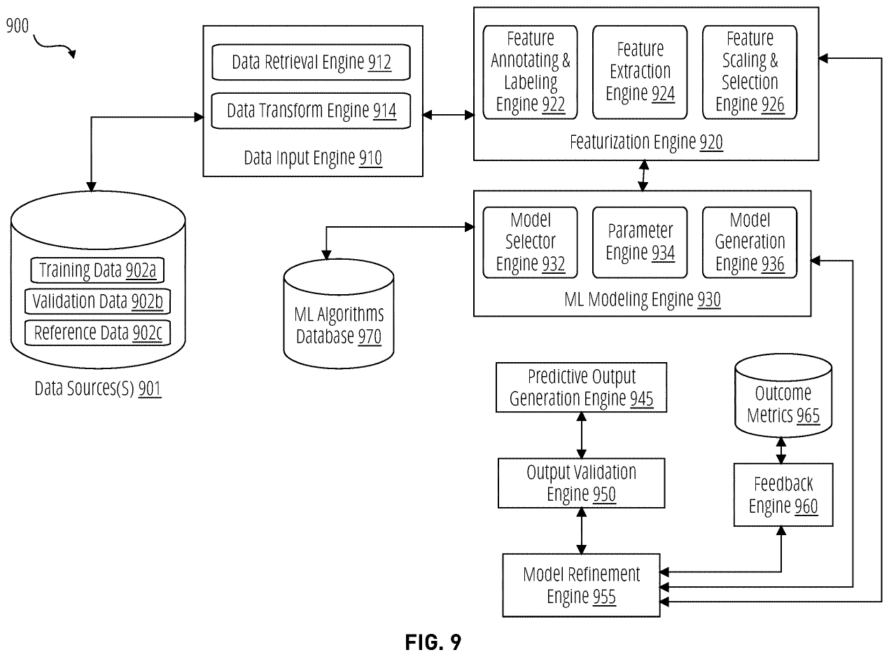

FIG. 9 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 900 may include data input engine 910 that can further include data retrieval engine 912 and data transform engine 914. Data retrieval engine 912 may be configured to access, interpret, request, or receive data, which may be adjusted, reformatted, or changed (e.g., to be interpretable by another engine, such as data input engine 910). For example, data retrieval engine 912 may request data from a remote source using an API. Data input engine 910 may be configured to access, interpret, request, format, re-format, or receive input data from data sources(s) 901. For example, data input engine 910 may be configured to use data transform engine 914 to execute a re-configuration or other change to data, such as a data dimension reduction. In some embodiments, data sources(s) 901 may be associated with a single entity (e.g., organization) or with multiple entities. Data sources(s) 901 may include one or more of training data 902a (e.g., input data to feed a machine learning model as part of one or more training processes), validation data 902b (e.g., data against which at least one processor may compare model output with, such as to determine model output quality), and/or reference data 902c. In some embodiments, data input engine 910 can be implemented using at least one computing device. For example, data from data sources(s) 901 can be obtained through one or more I/O devices and/or network interfaces. Further, the data may be stored (e.g., during execution of one or more operations) in a suitable storage or system memory. Data input engine 910 may also be configured to interact with a data storage, which may be implemented on a computing device that stores data in storage or system memory.

System 900 may include featurization engine 920. Featurization engine 920 may include feature annotating & labeling engine 922 (e.g., configured to annotate or label features from a model or data, which may be extracted by feature extraction engine 924), feature extraction engine 924 (e.g., configured to extract one or more features from a model or data), and/or feature scaling & selection engine 926 Feature scaling & selection engine 926 may be configured to determine, select, limit, constrain, concatenate, or define features (e.g., AI features) for use with AI models.

System 900 may also include machine learning (ML) ML modeling engine 930, which may be configured to execute one or more operations on a machine learning model (e.g., model training, model re-configuration, model validation, model testing), such as those described in the processes described herein. For example, ML modeling engine 930 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 902a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 930 may include model selector engine 932 (e.g., configured to select a model from among a plurality of models, such as based on input data), parameter engine 934 (e.g., configured to add, remove, and/or change one or more parameters of a model), and/or model generation engine 936 (e.g., configured to generate one or more machine learning models, such as according to model input data, model output data, comparison data, and/or validation data).

In some embodiments, model selector engine 932 may be configured to receive input and/or transmit output to ML algorithms database 970. Similarly, featurization engine 920 can utilize storage or system memory for storing data and can utilize one or more I/O devices or network interfaces for transmitting or receiving data. ML algorithms database 970 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 970 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 970 include versions DALL⋅E, CHAT GPT, and SORA, all provided by OPEN AI.

System 900 can further include predictive output generation engine 945 and output validation engine 950 (e.g., configured to apply validation data to machine learning model output). Predictive output generation engine 945 can analyze the input and identify relevant patterns and associations in the data it has learned to generate a sequence of words that predictive output generation engine 945 predicts is the most likely continuation of the input using one or more models from the ML algorithms database 970, aiming to provide a coherent and contextually relevant answer. Predictive output generation engine 945 generates responses by sampling from the probability distribution of possible words and sequences, guided by the patterns observed during its training. In some embodiments, predictive output generation engine 945 can generate multiple possible responses before presenting the final one. Predictive output generation engine 945 can generate multiple responses based on the input, and these responses are variations that predictive output generation engine 945 considers potentially relevant and coherent. Output validation engine 950 can evaluate these generated responses based on certain criteria. These criteria can include relevance to the prompt, coherence, fluency, and sometimes adherence to specific guidelines or rules, depending on the application. Based on this evaluation, output validation engine 950 selects the most appropriate response. This selection is typically the one that scores highest on the set criteria, balancing factors like relevance, informativeness, and coherence.

System 900 can further include feedback engine 960 (e.g., configured to apply feedback from a user and/or machine to a model) and model refinement engine 955 (e.g., configured to update or re-configure a model). In some embodiments, feedback engine 960 may receive input and/or transmit output (e.g., output from a trained, partially trained, or untrained model) to outcome metrics database 965. Outcome metrics database 965 may be configured to store output from one or more models and may also be configured to associate output with one or more models. In some embodiments, outcome metrics database 965, or other device (e.g., model refinement engine 955 or feedback engine 960), may be configured to correlate output, detect trends in output data, and/or infer a change to input or model parameters to cause a particular model output or type of model output. In some embodiments, model refinement engine 955 may receive output from predictive output generation engine 945 or output validation engine 950. In some embodiments, model refinement engine 955 may transmit the received output to featurization engine 920 or ML modeling engine 930 in one or more iterative cycles.

The engines of system 900 may be packaged functional hardware units designed for use with other components or a part of a program that performs a particular function (e.g., of related functions). Any or each of these modules may be implemented using a computing device. In some embodiments, the functionality of system 900 may be split across multiple computing devices to allow for distributed processing of the data, which may improve output speed and reduce computational load on individual devices. In some embodiments, system 900 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 900 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

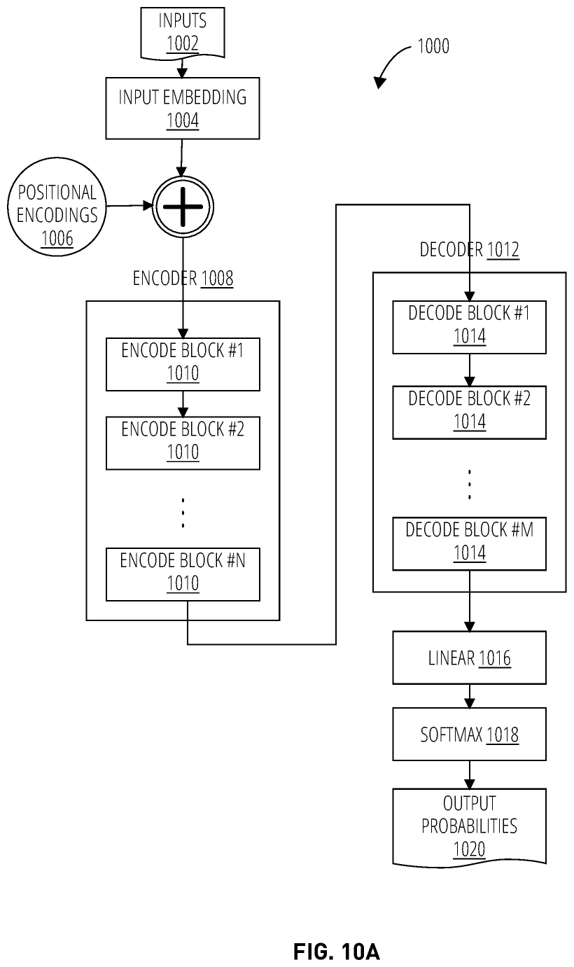

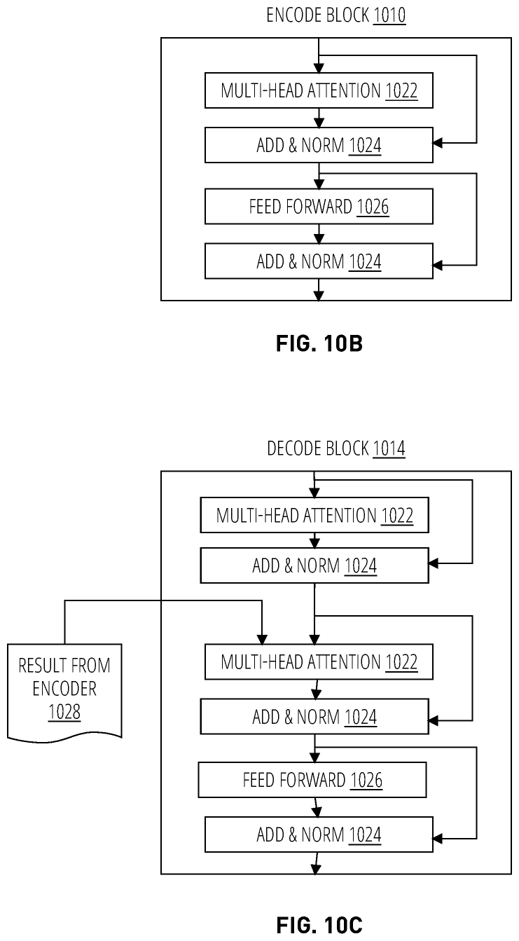

FIG. 10A, FIG. 10B, and FIG. 10C illustrates an example transformer architecture in accordance with some embodiments of the present technology. Examples of ML models that use a transformer neural network (e.g., transformer architecture 1000) can include, e.g., generative pretrained transformer (GPT) models and Bidirectional Encoder Representations from Transformer (BERT) models. The transformer architecture 1000, which is illustrated in FIG. 10A, FIG. 10B, and FIG. 10C, includes inputs 1002, input embedding block 1004, positional encodings 1006, encoder 1008 including encode blocks 1010, decoder 1012 including decode blocks 1014, linear block 1016, softmax block 1018, and output probabilities 1020.

Input embedding block 1004 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1004 can be learned embeddings to convert the input tokens and output tokens to vectors of dimension that have the same dimension as the positional encodings, for example.

Positional encodings 1006 provide information about the relative or absolute position of the tokens in the sequence. According to certain non-limiting examples, positional encodings 1006 can be provided by adding positional encodings to the input embeddings at the inputs to the encoder 1008 and decoder 1012. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1008 can use stacked self-attention and point-wise, fully connected layers. Encoder 1008 can be a stack of N identical layers (e.g., N=6), and each layer can be an encode block, as illustrated by encode block 1010 shown in FIG. 10B. Each encode block 1010 has two sub-layers:
(i) a first sub-layer has a multi-head attention block 1022 and (ii) a second sub-layer has a feed forward block 1026, which can be a position-wise fully connected feed-forward network. The feed forward block 1026 can use a rectified linear unit (ReLU).

Encoder 1008 uses a residual connection around each of the two sub-layers, followed by an add & norm block 1024, which performs normalization. For example, the output of each sub-layer can be LayerNorm(x+Sublayer(x)). To facilitate these residual connections, all sub-layers in the model, as well as the embedding layers, produce output data having a same dimension. The second multi-head attention block in FIG. 10C receives two inputs: (i) result from encoder 1028 and (ii) the output form add & norm block 1024 at the top of decode block 1014.

Similar to encoder 1008, decoder 1012 uses stacked self-attention and point-wise, fully connected layers. Decoder 1012 can also be a stack of M identical layers (e.g., M=6), and each layer can be a decode block, as illustrated by decode block 1014 shown in FIG. 10C. In addition to the two sub-layers (i.e., the sublayer with multi-head attention block 1022 and the sub-layer with feed forward block 1026) found in encode block 1010, decode block 1014 can include a third sub-layer, which performs multi-head attention over the output of the encoder stack. Similar to encoder 1008, decoder 1012 uses residual connections around each of the sub-layers, followed by layer normalization. Additionally, the sub-layer with multi-head attention block 1022 can be modified in the decoder stack to prevent positions from attending to subsequent positions. This masking, combined with the fact that the output embeddings are offset by one position, can ensure that the predictions for position i can depend only on the known output data at positions less than i.

Linear block 1016 can be a learned linear transformation. For example, when transformer architecture 1000 is being used to translate from a first language into a second language, linear block 1016 can project the output from the last decode softmax block 1018 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1018 then turns the scores from linear block 1016 into output probabilities 1020 (which add up to 1.0). In each position, the index provides for the word with the highest probability, and then maps that index to the corresponding word in the vocabulary. Those words then form the output sequence of transformer architecture 1000. The softmax operation is applied to the output from linear block 1016 to convert the raw numbers into output probabilities 1020 (e.g., token probabilities).

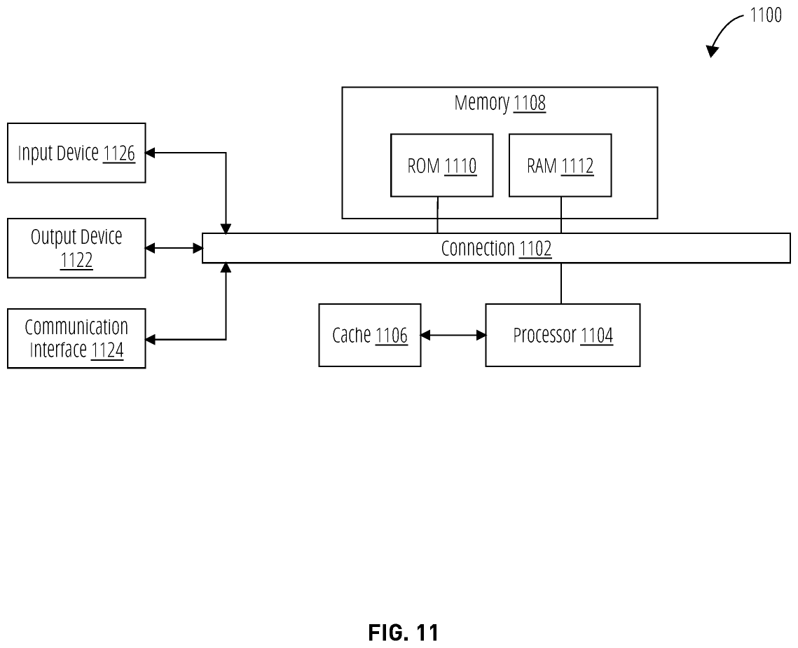

FIG. 11 shows an example of computing system 1100, which can be, for example, any computing device making up any ML model system illustrated in FIG. 1A and/or FIG. 1B or any component thereof. Further, computing system 1100 can be any computing device performing any of the steps or processes of methods 400 illustrated in FIG. 4 or any component thereof.

In some embodiments, computing system 1100 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 1100 may comprise one or more computing resources provisioned from a “cloud computing” provider, for example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1100 includes at least one processing unit (CPU or processor) 1104 and connection 1102 that couples various system components including system memory 1108, such as read-only memory (e.g., ROM 1110) and random access memory (e.g., RAM 1112) to processor 1104. Memory 1108 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1108 can include software services, servers, logic, etc., that when the code that defines such software is executed by the processor 1104, it causes the system to perform a function. In some embodiments, a hardware service that performs a particular function can include the software component stored in a computer-readable medium in connection with the necessary hardware components, such as processor 1104, connection 1102, output device 1122, etc., to carry out the function.

Computing system 1100 can include a cache of high-speed memory 1106 connected directly with, in close proximity to, or integrated as part of processor 1104.

Connection 1102 can be a physical connection via a bus, or a direct connection into processor 1104, such as in a chipset architecture. Connection 1102 can also be a virtual connection, networked connection, or logical connection.

Processor 1104 can include any general-purpose processor and a hardware service or software service stored in memory 1108, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi-core processor may be symmetric or asymmetric. Processor 1104 can be physical or virtual.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multi-modal systems can enable a user to provide multiple types of input/output to communicate with computing system 1100. Computing system 1100 can include communication interface 1124, which can generally govern and manage the user input and system output. There is no restriction on operating on any particular hardware arrangement, and therefore the basic features here may easily be substituted for improved hardware or firmware arrangements as they are developed.

In some embodiments, computing system 1100 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:
Aspect 1. A method for using machine learning (ML) and models created thereby, comprising: receiving a training set for fine-tuning an ML model, the training set comprising a plurality of images associated with respective text strings; receiving information indicating a base model that is to be fine-tuned using the training set; causing a fine-tuned ML model to be trained based on the base model and the training set; and returning a first identifier that identifies the fine-tuned ML model, which has been fine-tuned using the training set, wherein the first identifier is used to call the fine-tuned ML model.
Aspect 2. The method of aspect 1, wherein: the training set comprises inputs associated with outputs, the inputs including the plurality of images and input text, and the outputs including labels for supervised learning as the respective text strings that are associated with the plurality of images.
Aspect 3. The method of aspect 1 or aspect 2, comprising: providing feedback regarding the training set before the ML model is fined-tuned using the training set; and receiving, in response to providing the feedback, modifications to the training set to provide a modified training set, wherein the fine-tuned ML model has been fine-tuned using the modified training set as the training set.
Aspect 4. The method of aspect 3, wherein providing the feedback includes: preventing the training set from being used to fine-tune when the training set violates or fails to satisfy one or more predefined safety criteria, and signaling to a user an indication why the training set violates or fails to satisfy the one or more predefined safety criteria.
Aspect 5. The method of any of aspects 1-4, further comprising: screening the training set based on one or more predefined safety criteria; removing one or more training items from the training set when the one or more training items violate or fail to satisfy the one or more predefined safety criteria; and causing the fine-tuned ML model to be trained based on the base model and the training set absent the one or more training items.
Aspect 6. The method of any of aspects 1-5, further comprising: restricting images in the training set to a predefined maximum size; receiving user input indicating whether oversized images that exceed the predefined maximum size are resized or subdivided into respective tiles.
Aspect 7. The method of aspect 6, further comprising: resizing an image of the training set that exceeds the predefined maximum size, when the user input indicates that the oversized images are resized, wherein resizing the image includes scaling down the image to generate a reduced-sized image that does not exceed the predefined maximum size; and subdividing the image into a plurality of image tiles, when the user input indicates that the oversized images are subdivided into the respective tiles, wherein subdividing the image into the plurality of image tiles includes maintaining a scale of the image and determining as as the plurality of image tiles an order array of patches that individually do not exceed the predefined maximum size and that collectively span the image.
Aspect 8. The method of any of aspects 1-7, comprising: providing progress indicia for fine-tuning of the ML model, wherein the ML model is fine-tuned by updating weighting coefficients of the ML model to optimize one or more metrics when the training set is applied the ML model, and the progress indicia represents values at respective steps of the fine-tuning for the one or more metrics being optimized.
Aspect 9. The method of any of aspects 1-8, wherein the ML model is fine-tuned using supervised fine-tuning in which weighting coefficients of low-rank adaptation layers are updated, while pretrained weighting coefficients of the base model are maintained constant.
Aspect 10. The method of aspect 8, wherein: the ML model receives an input including a text input and an image input, the ML model tokenizes the text input to generate text tokens, the ML model tokenizes the image input to generate first tokens, applies the first tokens to one or more embedding layers to generate second tokens, and the second tokens together with the text tokens are applied to a language model to generate a text output.
Aspect 11. The method of any of aspects 1-10, wherein: the training set and the information indicating the base model to be used for fine tuning is received via an application programming interface (API) call, and the first identifier is returned in response to the API call.
Aspect 12. The method of any of aspects 1-11, wherein: the fine-tuned ML model includes an image embedding layer, the base model having fixed weighting coefficients, and a fine-tuned part having adjustable weighting coefficients, and the base model lacks the image embedding layer and the base model cannot receive image inputs.
Aspect 13. The method of aspect 12, wherein the image embedding layer comprises a contrastive language-image pre-training (CLIP) model that maps image tokens to image embeddings.
Aspect 14. The method of any of aspects 1-13, comprising: receiving an application programming interface (API) call requesting that the fine-tuned ML model be used to generate a response to a multi-modal input that includes input text and at least one input image, the call API referring to the first identifier of the fine-tuned ML model and including the multi-modal input; causing the multi-modal input to be applied to the fine-tuned ML model to generate the response; and returning the response including generated text that is generated by the fine-tuned ML model in response to the multi-modal input.
Aspect 15. A method of using machine learning (ML) and models created thereby, the method comprising: sending, to an application programming interface (API), a first API call including a training request and information of a training set, the training set including input images and text outputs, and the training request requesting that a fine-tuned ML model be generated based on the training set and based on a specified base model; and receiving, in response to the first API call, a first identifier that identifies the fine-tuned ML model, which has been fine-tuned using the training set.
Aspect 16. The method of aspect 15, further comprising: sending, to the API, a second API call requesting a response from the fine-tuned ML model to a multi-modal input, the second API call including the first identifier and the multi-modal input, the multi-modal input including input text and at least one input image; and receiving, in response to the second API call, the response that is generated by the first fine-tuned ML model in response to the multi-modal input.
Aspect 17. A computing apparatus comprising: a processor; and a memory storing instructions that, when executed by the processor, configure the computing apparatus to: perform the method of any of aspects 1-16.
Aspect 18. A non-transitory computer-readable storage medium, the computer-readable storage medium including instructions that when executed by a computer, cause the computer to: perform the method of any of aspects 1-16.

1. A method for using machine learning (ML) and models created thereby, comprising:
receiving, via an application programming interface (API) call, a training set for fine-tuning an ML model, the training set comprising a plurality of images associated with respective text strings;
receiving, via the API call, information indicating a first model that is to be fine-tuned using the training set;
causing a fine-tuned ML model to be trained based on the first model and the training set by performing supervised fine-tuning in which, for at least one layer of the first model having a pretrained weight matrix, pretrained weighting coefficients of the pretrained weight matrix are maintained constant while weighting coefficients of a first trainable matrix and a second trainable matrix of a low-rank adaptation layer are updated; and
returning, in response to the API call, a first identifier that identifies the fine-tuned ML model, which has been fine-tuned using the training set,
wherein the first identifier is used to call the fine-tuned ML model, and the first model is a base model or a previously fine-tuned model.

2. The method of claim 1, further comprising:
determining values for one or more progress metrics representing a state of the fine-tuned ML model at respective epochs of the fine-tuning, wherein a first progress metric of the one or more progress metrics depends on validation data associated with the training set.

3. The method of claim 1, wherein:
the fine-tuned ML model has been fine-tuned using the training set to perform supervised learning, and
the training set comprises inputs associated with outputs, each of the inputs including input text and at least one image of the plurality of images, and the outputs including, as the respective text strings of the training set, supervised-learning labels that are respectively associated with the inputs.

4. The method of claim 1, further comprising:
providing feedback regarding the training set before the ML model is fine-tuned using the training set; and
receiving, in response to providing the feedback, modifications to the training set to provide a modified training set,
wherein the fine-tuned ML model has been fine-tuned using the modified training set as the training set.

5. The method of claim 1, further comprising:
preventing the training set from being used to fine-tune when the training set violates or fails to satisfy one or more predefined safety criteria, and
signaling to a user an indication why the training set violates or fails to satisfy the one or more predefined safety criteria.

6. (canceled)

7. The method of claim 1, further comprising:
analyzing the fine-tuned ML model based on one or more predefined safety criteria, after the fine-tuned ML model has been trained using the first model and the training set; and
signaling to a user an indication that the fine-tuned ML model failed a safety test, when the fine-tuned ML model fails to satisfy one or more predefined safety criteria.

8. The method of claim 1, further comprising:
restricting images in the training set to a predefined maximum size; and
receiving user input indicating whether oversized images that exceed the predefined maximum size are resized or subdivided into respective tiles.

9. The method of claim 8, further comprising:
resizing an image of the training set that exceeds the predefined maximum size, when the user input indicates that the oversized images are resized, wherein resizing the image includes scaling down the image to generate a reduced-sized image that does not exceed the predefined maximum size; and
subdividing the image into a plurality of image tiles, when the user input indicates that the oversized images are subdivided into the respective tiles, wherein subdividing the image into the plurality of image tiles includes maintaining a scale of the image and determining as the plurality of image tiles an order array of patches that individually do not exceed the predefined maximum size and that collectively span the image.

10. The method of claim 1, further comprising:
providing progress indicia for fine-tuning of the ML model,
wherein the ML model is fine-tuned by updating the weighting coefficients of the first trainable matrix and the second trainable matrix to optimize one or more metrics when the training set is applied the ML model, and
wherein the progress indicia represents values at respective steps of the fine-tuning for the one or more metrics being optimized.

11. (canceled)

12. The method of claim 1,
wherein the first model is automatically trained in response to the API call.

13. The method of claim 1, wherein:
the fine-tuned ML model includes an image embedding layer, the first model having fixed weighting coefficients, and a fine-tuned part having adjustable weighting coefficients, and
the first model lacks the image embedding layer and the first model cannot receive image inputs.

14. The method of claim 13, wherein the image embedding layer comprises a contrastive language-image pre-training (CLIP) model that maps image tokens to image embeddings.

15. The method of claim 1, comprising:
receiving a second API call requesting that the fine-tuned ML model be used to generate a response to a multi-modal input that includes input text and at least one input image, the second API call referring to the first identifier of the fine-tuned ML model and including the multi-modal input;
causing the multi-modal input to be applied to the fine-tuned ML model to generate the response; and
returning the response including generated text that is generated by the fine-tuned ML model in response to the multi-modal input.

16. A method of using machine learning (ML) and models created thereby, the method comprising:
sending, to an application programming interface (API), a first API call including a training request and information of a training set, the training set including input images and text outputs, and the training request requesting that a fine-tuned ML model be generated based on the training set and based on a specified first model, wherein the first API call includes an indication of a fine-tuning method selected by a user from among a plurality of available fine-tuning methods via a user interface; and
receiving, in response to the first API call, a first identifier that identifies the fine-tuned ML model, which has been fine-tuned using the training set,
wherein the specified first model is a base model or a previously fine-tuned model.

17. The method of claim 16, further comprising:
sending, to the API, a second API call requesting a response from the fine-tuned ML model to a multi-modal input, the second API call including the first identifier and the multi-modal input, the multi-modal input including input text and at least one input image; and
receiving, in response to the second API call, the response that is generated by the fine-tuned ML model in response to the multi-modal input.

18. A computing apparatus for using machine learning (ML) and models created thereby, the computing apparatus comprising:
a processor; and
a memory storing instructions that, when executed by the processor, configure the computing apparatus to:
receive, via an application programming interface (API) call, a training set for fine-tuning an ML model, the training set comprising a plurality of images associated with respective text strings;
receive, via the API call, information indicating a first model that is to be fine-tuned using the training set;
cause a fine-tuned ML model to be trained based on the first model and the training set by performing supervised fine-tuning in which, for at least one layer of the first model having a pretrained weight matrix, pretrained weighting coefficients of the pretrained weight matrix are maintained constant while weighting coefficients of a first trainable matrix and a second trainable matrix of a low-rank adaptation layer are updated; and
return, in response to the API call, a first identifier that identifies the fine-tuned ML model, which has been fine-tuned using the training set,
wherein the first identifier is used to call the fine-tuned ML model; and the first model is a base model or a previously fine-tuned model.

19. The computing apparatus of claim 18, wherein the instructions further configure the computing apparatus to:
restrict images in the training set to a predefined maximum size;
receive user input indicating whether oversized images that exceed the predefined maximum size are resized or subdivided into respective tiles;
resize an image of the training set that exceeds the predefined maximum size, when the user input indicates that the oversized images are resized, wherein resizing the image includes scaling down the image to generate a reduced-sized image that does not exceed the predefined maximum size; and
subdivide the image into a plurality of image tiles, when the user input indicates that the oversized images are subdivided into the respective tiles, wherein subdividing the image into the plurality of image tiles includes maintaining a scale of the image and determining as the plurality of image tiles an order array of patches that individually do not exceed the predefined maximum size and that collectively span the image.

20. (canceled)

21. The computing apparatus of claim 18, wherein the instructions further configure the computing apparatus to:
receive a second API call requesting that the fine-tuned ML model be used to generate a response to a multi-modal input that includes input text and at least one input image, the second API call referring to the first identifier of the fine-tuned ML model and including the multi-modal input;
cause the multi-modal input to be applied to the fine-tuned ML model to generate the response; and
return the response including generated text that is generated by the fine-tuned ML model in response to the multi-modal input.

22. The computing apparatus of claim 18, wherein:
the fine-tuned ML model includes an image embedding layer, the first model having fixed weighting coefficients, and a fine-tuned part having adjustable weighting coefficients, and
the first model lacks the image embedding layer and the first model cannot receive image inputs.

23. The method of claim 1, wherein the API call is received by an API mediating communication between a user or an application and a server.

24. The method of claim 1, wherein the first trainable matrix and the second trainable matrix together define a low-rank decomposition of an update to the pretrained weight matrix and wherein an output of the at least one layer is generated based on a combination of the pretrained weight matrix and the update to the pretrained weight matrix.

25. The method of claim 16, wherein the fine-tuning method selected by the user includes a low-rank adaptation and wherein the fine-tuned ML model has been fine-tuned using the training set by performing supervised fine-tuning in which, for at least one layer of the specified first model having a pretrained weight matrix, pretrained weighting coefficients of the pretrained weight matrix are maintained constant while weighting coefficients of a first trainable matrix and a second trainable matrix of a low-rank adaptation layer are updated.

26. The computing apparatus of claim 18, wherein:
the training set includes inputs associated with outputs, the inputs including the plurality of images and input text, and the outputs including labels for supervised learning as the respective text strings that are associated with the plurality of images, and
the first trainable matrix and the second trainable matrix together define a low-rank decomposition of an update to the pretrained weight matrix and wherein an output of the at least one layer is generated based on a combination of the pretrained weight matrix and the update to the pretrained weight matrix.
